(19) United States
(12) Patent Application Publication
(10) Pub. No.: US 2005/0179386 A1
(43) Pub. Date: Aug. 18, 2005

(54) Plasma picture screen with enhanced efficiency

(76) Inventors: Hans-Helmut Bechtel, Roetgen (DE); Wolfgang Busselt, Roetgen (DE); Joachim Opitz, Aachen (DE); Tim Dekker, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/510,300

(22) PCT Filed: Apr. 7, 2003
(86) PCT No.: PCT/IB03/01400

(30) Foreign Application Priority Data
Apr. 11, 2002 (DE) 10215891.6

(51) Int. Cl. H01J 17/49; H01J 11/02

(52) U.S. Cl. 313/587; 313/582

(57) ABSTRACT

The invention relates to a plasma picture screen with a powder layer (8) in the plasma cells, which layer has a low dielectric constant K and thus reduces the discharge capacitance in the plasma cell. Such a plasma picture screen has an enhanced efficiency and an enhanced luminance.

The invention relates to a plasma picture screen provided with a front plate which comprises a transparent plate on which a dielectric layer and a protective layer are provided, with a carrier plate provided with a phosphor layer, with a ribbed structure subdividing the space between the front plate and the carrier plate into plasma cells filled with a gas, and with one or several electrode arrays on the front plate and the carrier plate for the generation of corona discharges in the plasma cells.

Plasma picture screens render possible color pictures with high resolution and large picture screen diameter and have a compact construction. A plasma picture screen comprises a hermetically closed space which is filled with a gas, usually with electrode arrays arranged in a grid. Individually controllable plasma cells are created by means of separating ribs, in which cells the application of a voltage leads to a gas discharge which generates light in the ultraviolet range. This light can be converted into visible light by means of phosphors and can be emitted through the front plate of the cell to a viewer.

Two types of plasma picture screens are distinguished in principle: a matrix arrangement of the electrodes and a coplanar arrangement of the electrodes. In the matrix arrangement, the gas discharge is ignited and maintained at the intersection of two electrodes of the front plate and the carrier plate. In the coplanar arrangement of the electrodes, the gas discharge is maintained between the electrodes on the front plate and ignited at the intersection with an electrode, a so-called address electrode, on the back plate. The address electrode in this case lies below the phosphor layer.

The front plate of a plasma picture screen comprises a transparent plate on which usually a plurality of parallel discharge electrodes is provided. The discharge electrodes usually comprise ITO layers and bus electrodes. Bus electrodes are narrow metal layers, one of which is present on each ITO layer. The discharge electrodes are covered with a transparent layer of a dielectric material, usually a low-melting glass. A protective layer, usually comprising MgO, is provided on this dielectric layer.

The discharge capacitance in the individual plasma cells is determined on the one hand by the layer thicknesses of the layers provided on the discharge electrodes, the dielectric layer, and the protective layer, and on the other hand by the dielectric constant K of the materials used in these layers. The value of the dielectric constant K of the dielectric layer lies between 8 and 9. The value of the dielectric constant K of a protective layer of MgO lies at around 9. It is known that the efficiency of a picture screen decreases as the discharge capacitance increases.

It is accordingly an object of the invention to provide an improved plasma picture screen.

This object is achieved by means of a plasma picture screen provided with a front plate which comprises a transparent plate on which a dielectric layer and a protective layer are provided, with a carrier plate provided with a phosphor layer, with a ribbed structure subdividing the space between the front plate and the carrier plate into plasma cells filled with a gas, with one or several electrode arrays on the front plate and the carrier plate for generating corona discharges in the plasma cells, and with a powder layer between the electrode arrays on the front plate and the electrode arrays on the carrier plate.

The introduction of a powder layer into the plasma cells renders it possible to reduce the discharge capacitance, because a powder layer has a low dielectric constant K. A powder layer usually has a proportional quantity of the powder material per volume of no more than 60%. That means that the density of the powder layer is ≦60% of the theoretical density. The dielectric constant K of such a powder layer is substantially determined by the matrix, which is air in this case.

The dielectric constant K of a powder layer with a proportional quantity per volume of the matrix Vₘ having a dielectric constant Kₘ and a proportional quantity per volume of the powder material Vₚ having a dielectric constant Kₚ is given by the Maxwell equation:

$$K = \frac{{V}_{m} {K}_{m} ( \frac{2}{3} + \frac{{K}_{p}}{3 {K}_{m}} ) + {V}_{p} {K}_{p}}{{V}_{m} ( \frac{2}{3} + \frac{{K}_{p}}{3 {K}_{m}} ) + {V}_{p}}$$

A plasma picture screen is known from JP 09-102280 A which comprises a sputtered layer of TiO₂, SiO₂, or Al₂O₃ in the plasma cell. The sputtered layers of TiO₂ or Al₂O₃, however, have dielectric constants K of 86 for TiO₂ and 9.3 for Al₂O₃, so that they not lower the discharge capacitance of the plasma cell. The use of a powder layer has the additional advantage that, in contrast to the use of a sputtered layer, no adhesion problems arise in a plasma picture screen according to the invention between a powder layer and other layers, for example the protective layer of MgO as described in JP 09-102280. In particular a sputtered layer of SiO₂, which has a comparatively low dielectric constant K of 4.6, adheres very badly to the protective layer of MgO.

The advantageous embodiment of claim 2 renders it possible in particular to reduce the discharge capacitance between the discharge electrodes and the gas discharge.

The advantageous embodiments of claims 3 and 4 ensure that a sufficient quantity of visible light issues through the front plate to the viewer.

The advantageous embodiment of claim 5 ensures a low dielectric constant K of the powder layer.

The advantageously chosen materials of claim 6 are resistant to the rigid manufacturing and operating conditions of plasma picture screens, in particular to high temperatures.

The invention will be explained in more detail below with reference to a drawing, in which:

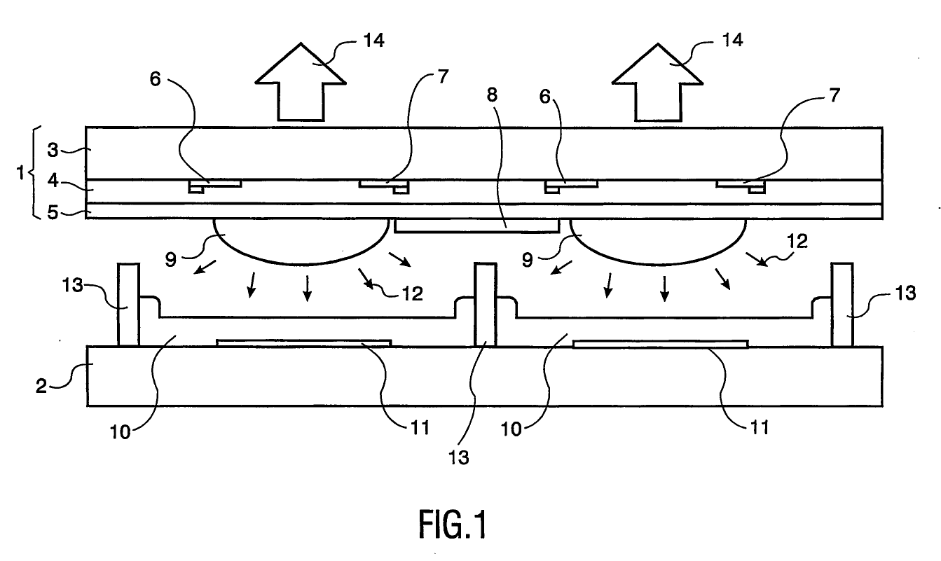

FIG. 1 shows the construction and operating principle of a single plasma cell in an AC plasma picture screen,

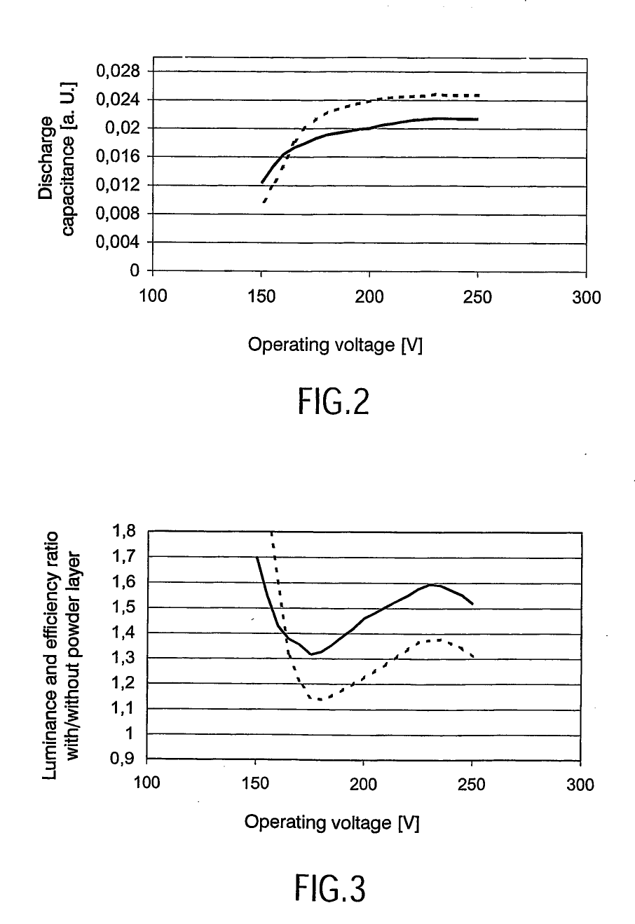

FIG. 2 shows the measured discharge capacitance as a function of the operating voltage in a plasma picture screen according to the invention, and

FIG. 3 shows the ratio of the luminance or efficiency of a plasma picture screen with a powder layer to that of a plasma picture screen without powder layer as a function of the operating voltage.

In FIG. 1, a plasma cell of an AC plasma picture screen with a coplanar arrangement of the electrodes comprises a front plate 1 and a carrier plate 2. The front plate 1 comprises a transparent plate 3, for example made of glass, on which a dielectric layer 4, preferably comprising low-melting glass, and thereon a protective layer 5, preferably comprising MgO are present. Parallel, strip-shaped discharge electrodes 6, 7 are provided on the transparent plate 7 and are covered by the dielectric layer 4. The discharge electrodes 6, 7 are made, for example, from metal, ITO, or a combination of a metal and ITO. Preferably, the discharge electrodes 6, 7 each comprise a strip of ITO on which a narrower layer of Al or Ag is provided as a bus electrode each time. The carrier plate 2 is preferably made of glass, and parallel, strip-shaped address electrodes 11, for example made of Ag, are provided on the carrier plate 2 so as to run perpendicularly to the discharge electrodes 6, 7. Said address electrodes are covered by a phosphor layer 10 which emits light 14 in one of the three basic colors red, green, and blue. The phosphor layer 10 is subdivided into several color segments for this purpose. A ribbed structure 13 with separating ribs of preferably a dielectric material serves to form individually controllable plasma cells in which corona discharges take place.

A gas is present in the plasma cell, and also between the discharge electrodes 6, 7, which act as the cathode and the anode in mutual alternation. The gas may be, for example, a rare gas, a mixture of rare gases with Xe as the UV-emitting component, nitrogen, or a mixture of nitrogen and at least one rare gas such as, for example, He, Ne, Kr, or Xe. After ignition of the surface discharge, enabling charges to flow along a discharge path lying between the discharge electrodes 6, 7 in the plasma region 9, a plasma arises in the plasma region 9 which generates radiation 12 in the (V)UV range, in dependence on the composition of the gas. The radiation 12 excites the phosphor layer 10 into luminance, thus causing this layer to emit visible light 14, which issues through the front plate 1 to the exterior and thus generates a luminous dot on the picture screen. The phosphor layer 10 is subdivided into several color segments. Usually the red-, green-, and blue-emitting color segments of the phosphor layer 10 are provided in the form of perpendicular strip triplets. A plasma cell with one color segment forms a so-termed sub-pixel. Three mutually adjoining plasma cells with a respective red-, green-, and blue-emitting color segment together form one pixel or picture element.

A powder layer 8 is introduced between the electrode arrays 6, 7 on the front plate 1 and the electrode arrays 11 on the carrier plate 2, preferably on the protective layer 5. If the powder layer 8 is provided on the protective layer 5, it is advantageous for the powder layer 8 to be provided in strip-shaped sections. Since the powder layer has mainly scattering properties, it is advantageous to keep the surface area of the powder layer 8 covering the protective layer 5 small. In a three-electrode arrangement, it is also advantageous when a strip-shaped section of the powder layer 8 in a plasma cell is provided such that it is located opposite the intervening space between the pairs of discharge electrodes 6, 7 of each individual plasma cell. It may also be advantageous for the strip-shaped section of the powder layer 8 to lie in addition partly opposite the discharge electrodes 6, 7, i.e. overlapping the latter.

The powder material used in the powder layer 8 may be a dielectric material such as, for example, an oxide or a phosphor. The particles of the powder materials preferably have a particle size of between 20 nm and 20 μm. It is advantageous here when the density of the powder layer 8 is ≦60% of the density of the powder material itself. The density of the powder material is determined as the quotient of the layer weight of the powder layer 8 and the thickness of the powder layer 8.

Depending on the dielectric material used for the powder material and its particle size, the powder layer 8 may reflect UV radiation. The efficiency of the plasma picture screen is enhanced in this case, because the UV radiation 12 generated in the gas discharge and not emitted towards the phosphor layer 10, but towards the front plate 1, will be reflected in the direction of the phosphor layer 10 and become available there for the generation of light.

It may also be advantageous that the powder material used for the powder layer 8 is a phosphor. This phosphor may emit, for example, in the visible range of light. It is preferred in this embodiment that a blue-emitting phosphor is used as the powder material in a plasma cell with a blue-emitting color segment of the phosphor layer 10, that a red-emitting phosphor is used in a plasma cell with a red-emitting color segment of the phosphor layer 10, and that a green-emitting phosphor is used in a plasma cell with a green-emitting color segment of the phosphor layer 10. In this embodiment, the efficiency of the plasma picture screen is enhanced in that the UV radiation 12 generated in the gas discharge and not emitted towards the phosphor layer 10, but towards the front plate 1, will be absorbed by the phosphors in the powder layer 8 and be converted into visible light, which passes through the front plate 1 to the viewer.

It is alternatively possible to use phosphors in the powder layer 8 which are excited by the UV radiation 12 from the plasma discharge and which subsequently emit longer-wave UV radiation. In this embodiment, the efficiency of the plasma picture screen is enhanced in that the UV radiation 12 generated in the gas discharge and not emitted towards the phosphor layer 10, but towards the front plate 1, is absorbed by the phosphors in the powder layer 8 and converted into longer-wave UV radiation, which is converted into visible light by the phosphors in the phosphor layer 10.

To manufacture a plasma picture screen with a powder layer 8 in the plasma cells, first a front plate 1 is manufactured in a usual process. The powder layer 8 is preferably provided by silk screen printing. To this end, first a silk screen printing paste is prepared from a silk screen printing paste base and the powder material. The silk screen printing paste base is preferably p-menth-1-en-8-ol with 5% ethyl cellulose by weight. Alternatively, the silk screen printing paste may comprise further additives such as, for example, dispersing agents or thixotropic agents.

The resulting silk screen printing paste is applied by means of silk screen printing, for example on the protective layer 5 of a front plate 1. Preferably, the silk screen printing paste is provided in strip-shaped sections and dried. Then the entire front plate 1 is exposed to a temperature of 485° C. The layer thickness of the finished powder layer 8 preferably lies between 2 and 15 μm.

### Embodiment 1

To prepare a silk screen printing paste, 100 g of a solvent mixture of 80% diethyleneglycolmonoethyletheracetate by weight and 20% p-menth-1-en-8-ol by weight comprising 5% ethyl cellulose by weight, 2.7 g of a thixotropic agent, and 10 g SiO₂ with a particle diameter of between 20 and 110 nm were mixed and subsequently dispersed in that they were passed twice through a triple roller mill.

A powder layer 8 of SiO₂ particles was provided in the form of strip-shaped sections by means of silk screen printing on the protective layer 5 of MgO of a front plate 1, which front plate comprises a glass plate 3, a dielectric layer 4, a protective layer 5, and discharge electrodes 6, 7. The distance between two discharge electrodes 6, 7 in a plasma cell was 200 μm each time. The dielectric layer 4 comprised PbO, and the two discharge electrodes 6, 7 were made of ITO and Ag. The front plate 1 was first dried and then subjected to a thermal aftertreatment at 450° C. for 2 hours. The layer thickness of the powder layer 8 of SiO₂ was 5.0 μm, and the width of the strip-shaped sections was 200 μm. The strip-shaped sections of the powder layer 8 were provided such that they were located opposite the intervening spaces between the pairs of discharge electrodes 6, 7.

The front plate 1 was used for assembling a plasma picture screen in combination with a carrier plate 1 having a ribbed structure 12, a phosphor layer 10 comprising (Y,Gd)BO₃:Eu as the red-emitting phosphor, Zn₂SiO₄:Mn as the green-emitting phosphor, and BaMgAl₁₀O₁₇:Eu as the blue-emitting phosphor, and with a gas mixture comprising 5% Xe and 95% Ne by volume.

FIG. 2 shows the measured discharge capacitance of the plasma picture screen of embodiment 1 compared with that of a plasma picture screen without a powder layer 8 of SiO₂ as a function of the operating voltage. The broken line relates to the plasma picture screen without a powder layer 8, and the continuous line to the plasma picture screen with a powder layer 8.

FIG. 3 shows the ratio of the efficiency and luminance of a plasma picture screen of the embodiment compared with those of a plasma picture screen without the powder layer 8 of SiO₂ as a function of the operating voltage. The continuous line denotes the efficiency and the broken line denotes the luminance.

### Emdodiment 2

Three silk screen printing pastes were prepared in a manner analogous to that of embodiment 1, the first silk screen printing paste comprising (Y,Gd)BO₃:Eu instead of SiO₂, the second silk screen printing paste comprising Zn₂SiO₄:Mn instead of SiO₂, and the third silk screen printing paste comprising BaMgAl₁₀O₁₇:Eu instead of SiO₂. The concentration of the powder used instead of SiO₂ was 13% by weight in the paste when ready for use.

Strip-shaped sections with (Y,Gd)BO₃:Eu particles were provided by silk screen printing on the protective layer 5 of MgO of a front plate 1 which comprises a glass plate 3, a dielectric layer 4, a protective layer 5, and discharge electrodes 6, 7. The distance between the two discharge electrodes 6, 7 in a plasma cell was 200 μm each time. The dielectric layer 4 comprised PbO, and the two discharge electrodes 6, 7 were made of ITO and Ag. These strip-shaped sections of the powder layer 8 with (Y,Gd)BO₃:Eu particles were provided such that they were present in a plasma cell with a red-emitting phosphor in the finished plasma picture screen. Similarly, strip-shaped sections with Zn₂SiO₄:Mn particles were subsequently provided on the protective layer 5 such that these strip-shaped sections of the powder layer 8 were each present in a plasma cell with a green-emitting phosphor in the finished plasma picture screen. Similarly, strip-shaped sections with BaMgAl₁₀O₁₇:Eu particles were subsequently provided on the protective layer 5 such that these strip-shaped sections of the powder layer 8 were each present in a plasma cell with a blue-emitting phosphor in the finished plasma picture screen.

The front plate 1 was first dried and then subjected to a thermal aftertreatment at 450° C. for 2 hours. The layer thickness of the powder layer 8 was 8.0 μm, and the width of the strip-shaped sections was 240 μm. The strip-shaped sections of the powder layer 8 were provided such that they were located opposite the intervening spaces between the pairs of discharge electrodes 6, 7 and in addition partly overlapped said discharge electrodes 6, 7.

1. A plasma picture screen provided with a front plate (1) which comprises a transparent plate (3) on which a dielectric layer (4) and a protective layer (5) are provided, with a carrier plate (2) provided with a phosphor layer (10), with a ribbed structure (12) subdividing the space between the front plate (1) and the carrier plate (2) into plasma cells filled with a gas, with one or several electrode arrays (6, 7, 11) on the front plate (1) and the carrier plate (2) for generating corona discharges in the plasma cells, and with a powder layer (8) between the electrode arrays (6, 7) on the front plate (1) and the electrode arrays on the carrier plate (2).

2. A plasma picture screen as claimed in claim 1, characterized in that the powder layer (8) is provided on the protective layer (5).

3. A plasma picture screen as claimed in claim 2, characterized in that the powder layer (8) is provided in strip-shaped sections on the protective layer (5).

4. A plasma picture screen as claimed in claim 3, characterized in that the strip-shaped sections of the powder layer (8) are provided such that they each lie opposite the intervening space between pairs of respective discharge electrodes (6, 7).

5. A plasma picture screen as claimed in claim 1, characterized in that the density of the powder layer (8) is ≦60% of the density of the powder material.

6. A plasma picture screen as claimed in claim 1, characterized in that the powder layer (8) comprises a material chosen from the group of dielectric materials and phosphors.
